(19) United States
(12) Patent Application Publication
(10) Pub. No.: US 2006/0024479 A1
(43) Pub. Date: Feb. 2, 2006

(54) Grip tape and its fabrication method

(76) Inventor: Chun-Fu Chang, Taichung Hsien (TW)

Correspondence Address: CHARLES E. BAXLEY, ESQ., 90 JOHN STREET, THIRD FLOOR, NEW YORK, NY, 10038, US

(21) Appl. No.: 10/901,820

(22) Filed: Jul. 29, 2004

(51) Int. Cl. B32B 3/02

(52) U.S. Cl. 428/157

(57) ABSTRACT

A grip tape is constructed to have a felt layer and a polyurethane layer bonded to the felt layer, the polyurethane layer having a layer of elastic microporous and a layer of fine microporous between the layer of elastic microporous and the felt layer.

### BACKGROUND OF THE INVENTION

1. Field of the Invention

The present invention relates grip tape and more particularly, to such a grip tape, which comprises a felt layer, and a polyurethane layer formed of a layer of elastic microporous and a layer of fine microporous and bonded to the felt layer.

2. Description of the Related Art

A conventional grip tape is known comprising an elastic layer and a felt layer. The elastic layer is formed of polyurethane. During fabrication, polyurethane is mixed with dimethyl foramide at the ratio of about 1:0.8˜1:0.9 and then a pigment and surfactant are added to the PU mixture, and then the PU mixture thus obtained is applied to the surface of a wet felt having a humility about 20˜22%, and then the coated felt is dipped in a water bath to remove dimethyl foramide from polyurethane, and then the grip tape thus prepared is dried by heating. In order to eliminate protrusion of the grip tape after winding of the grip tape on a handle, the two opposite long sides of the bottom wall of the grip tape are beveled. However, when beveling the two opposite long sides of the bottom wall of the grip tape, the grip tape tends to break due to loose structure of the elastic layer. Further, because the whole structure of the elastic layer is loose, the grip tape is too soft to grasp positively.

### SUMMARY OF THE INVENTION

The present invention has been accomplished under the circumstances in view. It is therefore the main object of the present invention to provide a grip tape, which eliminates the aforesaid drawbacks. According to one aspect of the present invention, the grip tape comprises a felt layer and a polyurethane layer bonded to the felt layer. The polyurethane layer comprises a layer of elastic microporous, and a layer of fine microporous between the layer of elastic microporous and the felt layer. According to another aspect of the present invention, the grip tape has two beveled edges respectively extended along two opposite long sides of the bottom wall thereof, and two thin edges respectively formed in two opposite long sides of the top wall thereof. When wrapped about a handle, a spiral groove is formed on the grip tape around the handle corresponding to the thin edges. Therefore, the user can hold the grip comfortably and, the user's hand will never force the thin edges out of place. Further, the grip tape is made by: mixing polyurethane with dimethyl foramide at the ratio of about 1:0.6˜1:0.75 to prepare a PU mixture, and then using a scrapper to apply the PU mixture to the surface of a felt layer being wetted to have a humidity about 26˜30%, and then dipping the PU mixture-coated felt layer in a coagulation bath to let dimethyl foramide be dissolved in water so as to obtain a raw grip tape material, and then drying the material by heating.

### BRIEF DESCRIPTION OF THE DRAWINGS

FIG. 1 is an enlarged view of a grip tape constructed according to one embodiment of the present invention.

FIG. 2 is an enlarged view of a part of a grip tape constructed according to another embodiment of the present invention.

FIG. 3 is a cross-sectional view of the present invention, showing the cut edges and the thin edges on the bottom and top walls of the grip tape.

FIG. 4 is an applied view of the present invention, showing the winding of the grip tape on a handle.

FIG. 5 is a side view after winding of the grip tape on the handle according to the present invention.

FIG. 6 is a schematic drawing showing the hand grasped the grip tape on the handle according to the present invention.

FIG. 7 is a plain view of a grip tape according to another alternate form of the present invention.

FIG. 8A is a schematic drawing showing the operation of grip tape in FIG. 7 covers on a handle of the prior art (I).

FIG. 8B is a schematic drawing showing the operation of grip tape in FIG. 7 covers on a handle of the prior art (II).

FIG. 8C is a schematic drawing showing the operation of grip tape in FIG. 7 covers on a handle of the prior art (III).

FIG. 9 is a sectional view taken in an enlarged scale along line 9-9 of FIG. 7.

FIG. 10 is a sectional view taken in an enlarged scale along line 10-10 of FIG. 8A.

FIG. 11 is a transverse view in section of still another alternate form of the grip tape according to the present invention.

FIG. 12 is a cross-sectional view showing the grip tape of FIG. 11 wrapped about a handle.

FIG. 13 is a transverse view in section of still another alternate form of the grip tape according to the present invention.

FIG. 14 is a cross-sectional view showing the grip tape of FIG. 13 wrapped about a handle.

### DETAILED DESCRIPTION OF THE PREFERRED EMBODIMENT

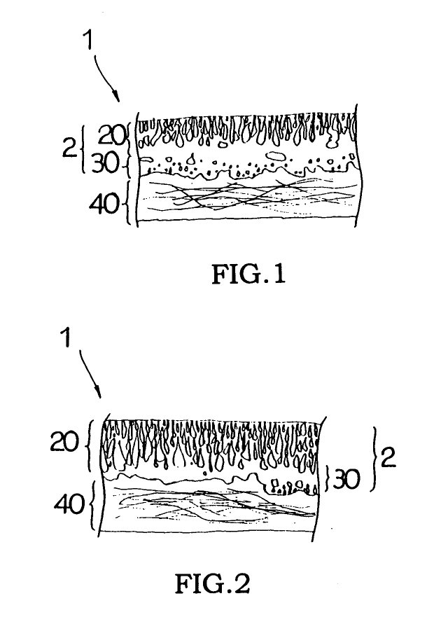

Referring to FIGS. 1 and 2, a grip tape 1 is shown comprising a PU (polyurethane) layer 2 and a felt layer 40. The PU layer 2 comprises a layer of elastic microporous 20 and a layer of fine microporous 30. The grip tape 1 is made by: mixing PU (polyurethane) with DMF (dimethyl foramide) at the ratio of about 1:0.6˜1:0.75, and then adding pigment and surfactant to the mixture, and then applying the mixture thus prepared with a scrapper to the surface of a felt layer 40 being wetted (to have a humidity about 26˜30%), and then putting the coated felt layer 40 in a coagulation bath to let DMF be dissolved in water and PU be hardened to form a layer of fine microporous 30 on the surface of the felt layer 40 and a layer of elastic microporous 20 on the layer of fine microporous 30. After formation of the layer of fine microporous 30 on the surface of the felt layer 40 and the layer of elastic microporous 20 on the layer of fine microporous 30, the coated felt layer 40 is dried by heating, and the desired finished product is thus obtained. The main difference between the layer of elastic microporous 20 and the layer of fine microporous 30 is the cell size. The size of the layer of fine microporous 30 is relatively smaller than the layer of elastic microporous 20. Therefore, the density of the layer of fine microporous 30 is relatively greater than the layer of elastic microporous 20.

Preferably, the thickness of the layer of fine microporous 30 is not greater than the total thickness of the PU layer 2.

In the embodiment shown in FIG. 1, the thickness of the layer of fine microporous 30 is about two third of the total thickness of the PU layer 2. In the embodiment shown in FIG. 2, the thickness of the layer of fine microporous 30 is smaller than two third of the total thickness of the PU layer 2.

The technical measure of the present invention is in the PU mixture to reduce the ratio of DMF, increase the ratio of PU, and increase the humidity of the felt layer 40. Because the humidity of the felt layer 40 is about 26˜30%, a part of DMF in the prepared PU mixture that touches the felt layer 40 is dissolving when covering of the prepared mixture on the wet felt layer 40. Because the dissolving speed of DMF is slow at this time, fine microporous are formed in the interface between the PU mixture and the felt layer 40. After having been put in the coagulation bath, DMF in the PU mixture is dissolved rapidly, thereby forming elastic microporous in the surface layer of the PU mixture. After drying, the desired grip tape 1 having a PU (polyurethane) layer 2 and a felt layer 40 is thus obtained, and the PU layer 2 has a layer of elastic microporous 20 at the top side and a layer of fine microporous 30 at the bottom side in conjunction with the felt layer 40.

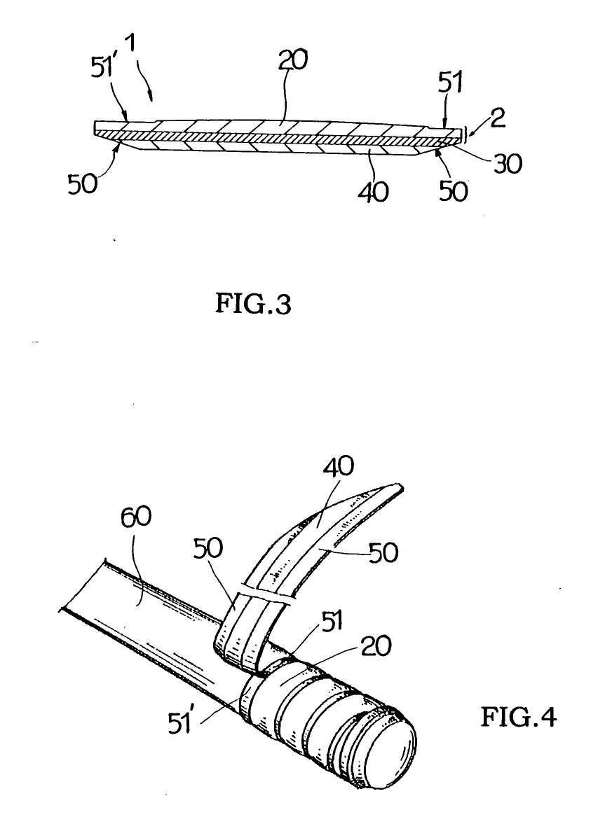

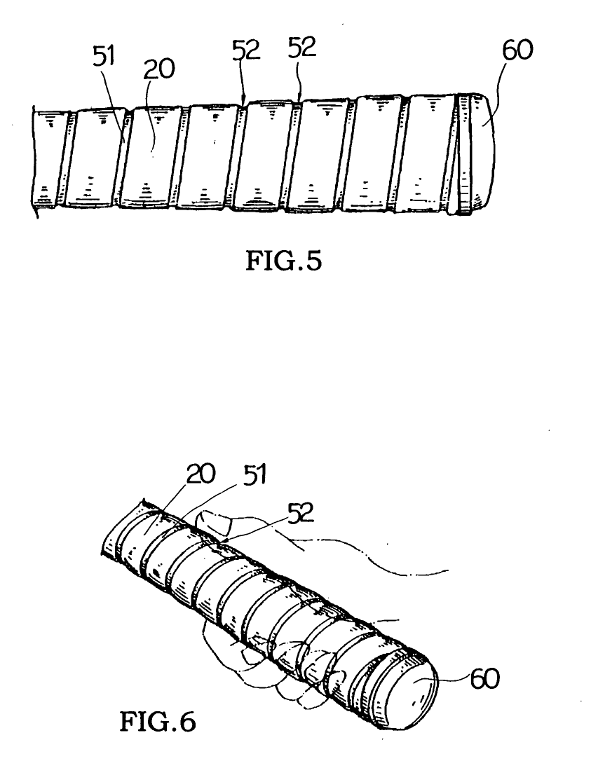

Referring to FIGS. 3˜6, the two opposite long sides of the bottom wall of the grip tape 1 are beveled, forming a respective cut edge 50. The two opposite long sides of the top wall (the top surface of the layer of elastic microporous 20) are compacted with a heat press to form a respective thin edge 51 or 51′. The thin edges 51, 51′ have different widths. When wrapping the grip tape 1 about a handle 60, one thin edge 51 is pressed on the other thin edge 51′. After wrapping, a spiral groove 52 is formed on the grip tape 1 around the handle 60 corresponding to the thin edges 51, 51′. Therefore, the user can hold the grip comfortably and, the user's hand will never force the thin edges 51, 51′ out of place.

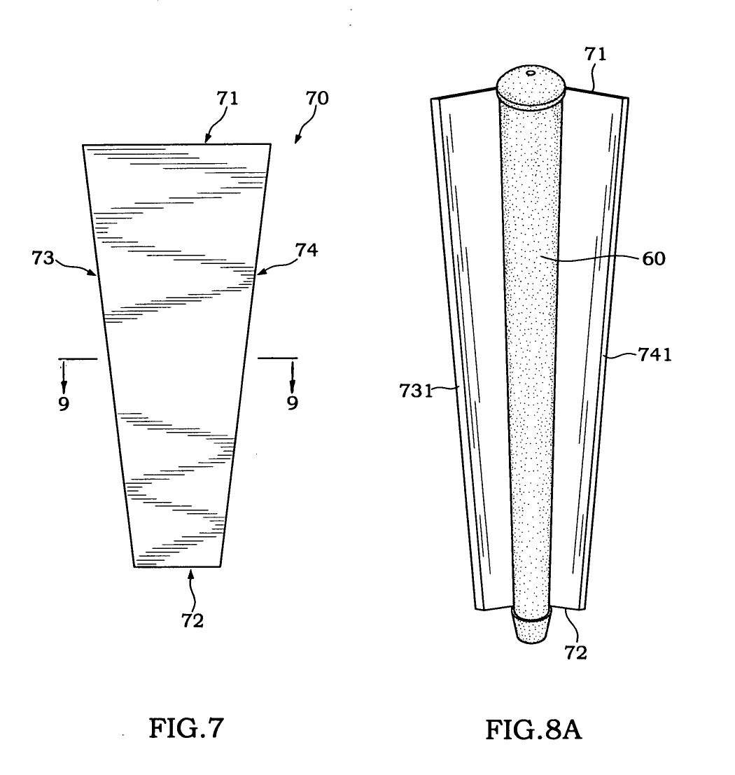

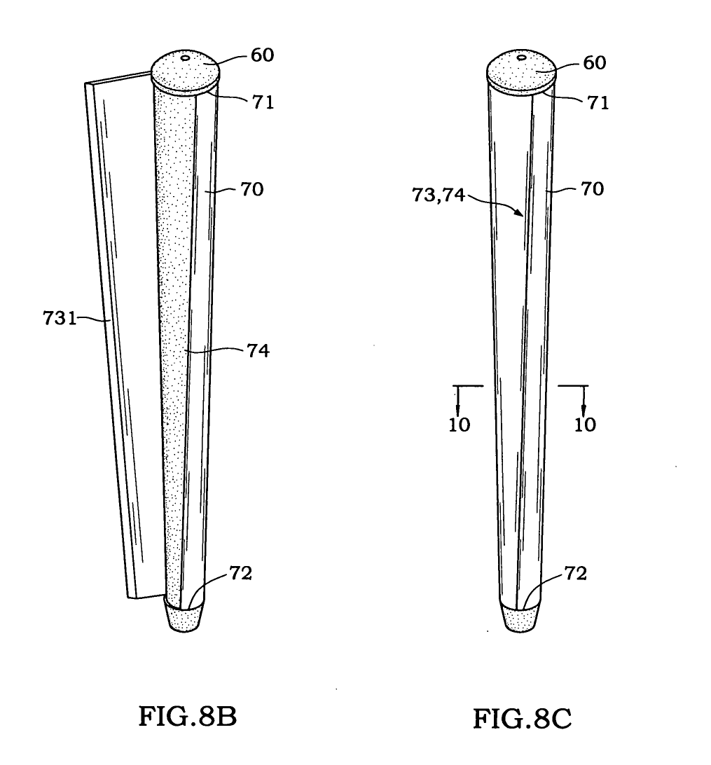

FIGS. 7 and 8 show another alternate form of the present invention. According to this alternate form, the grip tape 70 is shaped like a trapezoidal strip comprising a PU (polyurethane) layer 75 and a felt layer 76. When viewed from the front side, the grip tape 70 is shown having four sides, namely, the first side 71, the second side 72, the third side 73, and the fourth side 74. The third side 73 and the fourth side 74 have a respective cut edge 731 or 741. The exposed surface of the felt layer 76 and the cut edges 731 and 741 are covered with a layer of bonding agent (adhesive) for mounting.

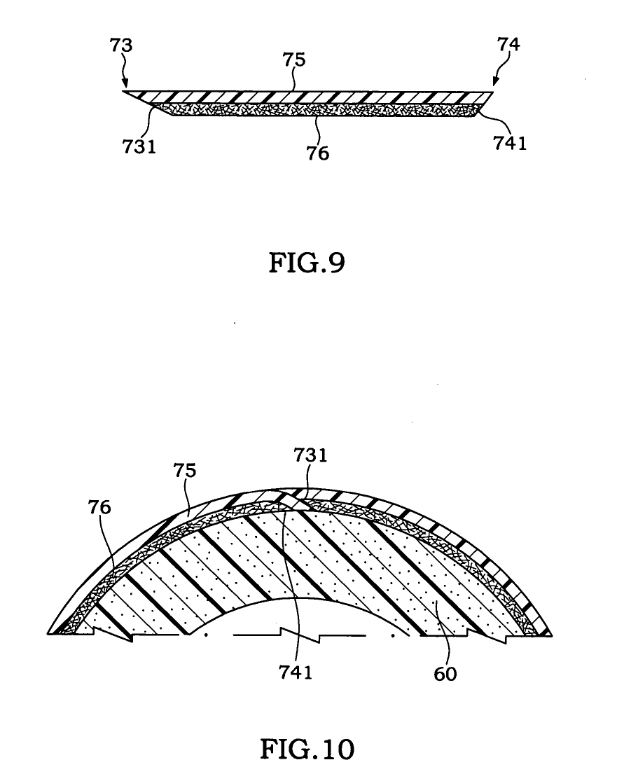

FIGS. 9 and 10 show the grip tape 70 wrapped about a handle 60 and fixedly secured thereto by the layer of bonding agent (adhesive). As illustrated, the first side 71 and second side 72 of the grip tape 70 are respectively bonded to the two distal ends of the handle 60, the body of the grip tape 70 is covered on the periphery of the handle 60, and the cut edges 731 and 741 of the third side 73 and fourth side 74 are abutted against each other in a flush manner.

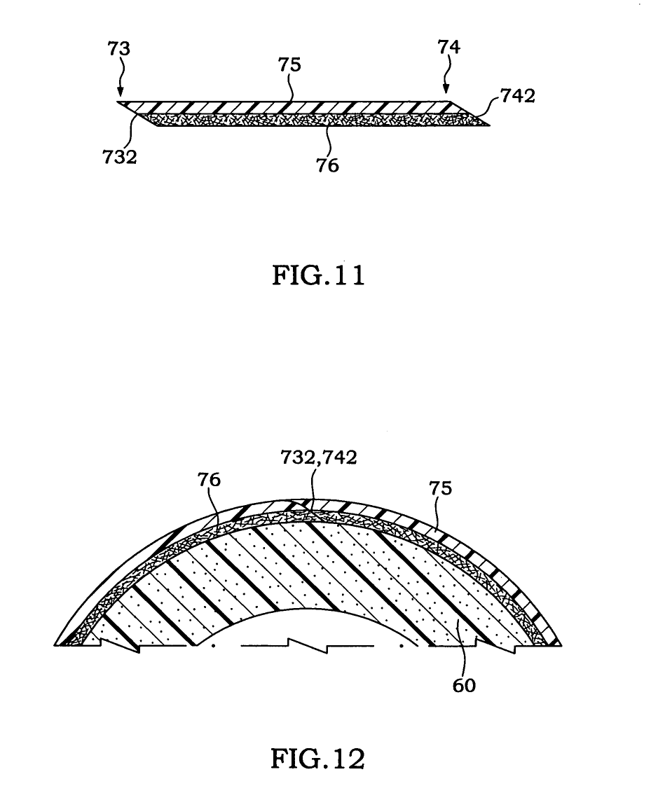

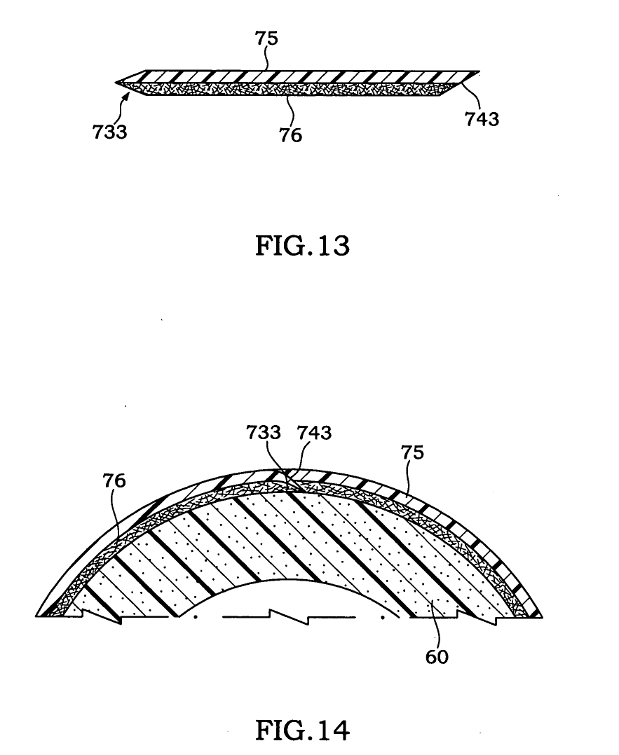

The two cut edges 731 and 741 of the grip tape 70 may be variously embodied. According to the embodiment shown in FIG. 8, the cut edges 731 and 741 of the grip tape 70 are formed in the PU (polyurethane) layer 75 and the felt layer 76 at two sides and sloping downwardly inwards toward each other. According to the embodiment shown in FIG. 11, the cut edges 732 and 742 of the grip tape 70 are formed in the PU (polyurethane) layer 75 and the felt layer 76 at two sides and sloping in same direction, i.e., the cut edges 732 and 742 are arranged in parallel. According to the embodiment shown in FIG. 13, one cut edge 733 is a double-bevel edge sloping downwardly outwards in one side of the PU (polyurethane) layer 75 and then sloping downwardly inwards in the respective side of the felt layer 76, and the other cut edge 743 is formed the PU (polyurethane) layer 75 and the felt layer 76 at the other side and sloping downwardly inwards. Referring to FIGS. 10, 12 and 14, after wrapping of either of the aforesaid different alternate forms of grip tape about a handle 60, the beveled edges are abutted against and adhered to each other in a flush manner.

A prototype of grip tape has been constructed with the features of FIGS. 1˜14. The grip tape functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A grip tape comprising a felt layer and a polyurethane layer bonded to said felt layer, said polyurethane layer comprising a layer of elastic microporous and a layer of fine microporous between said layer of elastic microporous and said felt layer.

2. The grip tape as claimed in claim 1, wherein said layer of fine microporous has a thickness smaller than two third of the total thickness of said polyurethane layer.

3. The grip tape as claimed in claim 1, wherein said layer of fine microporous has a thickness approximately equal to two third of the total thickness of said polyurethane layer.

4. The grip tape as claimed in claim 1, further comprising two beveled edges respectively extended along two opposite long sides of a bottom wall thereof, and two thin edges respectively formed in two opposite long sides of a top wall thereof.

5. The grip tape as claimed in claim 1, which has a trapezoidal profile.

6. The grip tape as claimed in claim 5, which has two cut edges respectively formed in and extended along two opposite long sides thereof.

7. The grip tape as claimed in claim 6, wherein said cut edges are covered with a layer of adhesive means.

8. The grip tape as claimed in claim 6, wherein said cut edges are respectively formed in said polyurethane layer and said felt layer at two sides and respectively sloping downwardly inwards.

9. The grip tape as claimed in claim 6, wherein said cut edges are respectively formed in said polyurethane layer and said felt layer at two sides and sloping in same direction.

10. The grip tape as claimed in claim 6, wherein said cut edges include a first cut edge and a second cut edge, said first cut edge being a double-bevel edge sloping downwardly outwards in one side of said polyurethane layer and then sloping downwardly inwards in the respective side of said felt layer, said second cut edge being formed in said polyurethane) layer and said felt layer at an opposite side and sloping downwardly inwards.

11. A grip tape fabrication method comprising the steps of:
a) mixing polyurethane with dimethyl foramide at the ratio of about 1:0.6˜1:0.75 to prepare a PU mixture;
b) using a scrapper to apply said PU mixture to the surface of a felt layer being wetted to have a humidity about 26˜30%;
c) putting said PU mixture-coated felt layer in a coagulation bath to let dimethyl foramide be dissolved in water, so as to obtain a raw grip tape material;
d) drying said raw grip tape material by heating into a finished grip tape having a felt layer and a polyurethane layer formed of a layer of elastic microporous and a layer of fine microporous between said layer of elastic microporous and said felt layer.

12. The grip tape fabrication method as claimed in claim 5, wherein said layer of fine microporous has a thickness smaller than two third of the total thickness of said polyurethane layer.

13. The grip tape as claimed in claim 5, wherein said layer of fine microporous has a thickness approximately equal to two third of the total thickness of said polyurethane layer.

14. The grip tape as claimed in claim 5, further comprising a sub-step of adding a surfactant to said PU mixture before applying said PU mixture to said felt layer.

15. The grip tape as claimed in claim 5, further comprising a sub-step of adding a pigment to said PU mixture before applying said PU mixture to said felt layer.
